(19) United States
(12) Patent Application Publication
(10) Pub. No.: US 2017/0090097 A1
(43) Pub. Date: Mar. 30, 2017

(54) LIGHT GUIDE PLATE AND BACK LIGHT UNIT AND LIQUID CRYSTAL DISPLAY HAVING THE LIGHT GUIDE PLATE

(71) Applicants: Shenzhen China Star Optoelectronics Technology Co., Ltd., Guangdong (CN); WUHAN CHINA STAR OPTOELECTRONICS TECHNOLOGY CO., LTD., Wuhan, Hubei (CN)

(72) Inventor: Yanxue ZHANG, Guangdong (CN)

(21) Appl. No.: 14/787,571

(22) PCT Filed: Jun. 5, 2015
(86) PCT No.: PCT/CN2015/080873

§ 371 Date: Oct. 28, 2015

(30) Foreign Application Priority Data
Mar. 27, 2015 (CN) 201510140646.4

(51) Int. Cl. F21V 8/00

(52) U.S. Cl. CPC G02B 6/0041; G02B 6/0068; G02B 6/002

(57) ABSTRACT

A light guide plate, having an light incident surface, a non-light-incident surface opposite to the light incident surface, and a confluence surface positioned between the light incident surface and the non-light-incident surface and opposite to the light incident surface, wherein the light incident surface includes at least one closed groove gradually reducing from the light incident surface towards the confluence surface, and a refraction element is filled between the confluence surface and the non-light-incident surface. Also disclosed is a light having a back light unit and a liquid crystal display having the light guide plate. The light guide plate improves light refractivity while improving light conductivity by disposing a closed groove and a refraction element in the light guide plate, thereby improving uniformity of luminance of the liquid crystal display panel.

### TECHNICAL FIELD

The present invention relates to a liquid crystal display technical field, more particularly, to a light guide plate and a back light unit and a liquid crystal display having the light guide plate.

### BACKGROUND ART

Back Light Unit (BLU) is one of important devices for a Liquid Crystal Display (LCD), which has been widespreadly applied to related products currently, such as a digital camera, a mobile telephone, a Personal Digital Assistant (PDA), a computer monitor and a flat-screen TV, etc. In general, BLU is most disposed at the back of a liquid crystal display panel, which includes a light source, a light guide plate, a reflection sheet, a diffusion plate and numerous types of optical films or prism sheets.

The function of the light guide plate lies in guiding a scattering direction of light generated by a light source to convert a point light source or a line light source of the BLU into a surface light source to be provided to the liquid crystal display panel, in order to improve luminance of the liquid crystal display panel and ensure uniformity of luminance of the liquid crystal display panel. In the design for the back light unit in the art, the improvement of uniformity of the surface light source of the liquid crystal display panel provided by the BLU is realized by improving netted dots on the bottom surface of the light guide plate. However, with uniformity of the surface light source of the liquid crystal display panel provided by the BLU being continuously required to be improved, it becomes quite difficult to improve uniformity of the surface light source of the liquid crystal display panel provided by the BLU only by improving netted dots on the bottom surface of the light guide plate.

### SUMMARY

In order to solve the problem existing in the prior art, the present invention provides a light guide plate capable of improving light conductivity and improving light refractivity and a back light unit and a liquid crystal display having the light guide plate.

According to one aspect of the present invention, a light guide plate is provided, which includes an light incident surface, a non-light-incident surface opposite to the light incident surface and a confluence surface positioned between the light incident surface and the non-light-incident surface and opposite to the light incident surface, the light incident surface includes at least one closed groove gradually reducing from the light incident surface towards the confluence surface, and a refraction element is filled between the confluence surface and the non-light-incident surface.

Furthermore, the closed groove has a taper shape.

Furthermore, the closed groove has a circular cone shape.

Furthermore, the bottom surface of the closed groove is a flat bottom surface

Furthermore, the refraction element includes a plurality of refractive particles and/or a plurality of bubbles.

Furthermore, the distance between the light incident surface and the confluence surface is equal to the distance between the non-light-incident surface and the confluence surface.

According to another aspect of the present invention, a back light unit is provided, which includes the above mentioned light guide plate and at least one light source disposed to face the light incident surface of the light guide plate and correspond to the closed grooves.

Furthermore, the light source is a point light source.

Furthermore, the light source is a light emitting diode.

According to another aspect of the present invention, a liquid crystal display is provided, which includes the above back light unit and a liquid crystal display panel disposed opposite to the back light unit, the back light unit provides a display light source for the liquid crystal display panel so that the liquid crystal display panel displays an image.

The advantageous effects of the present invention are as follows: the present invention improves light refractivity while improving light conductivity by disposing a closed groove and a refraction element in the light guide plate, thereby improving uniformity of luminance of the liquid crystal display panel.

### BRIEF DESCRIPTION OF THE DRAWINGS

These and/or other aspects, characteristics and advantages of the embodiments in the invention will become more apparent from the following description, taken in conjunction with the accompanying drawings in which:

FIG. 1 is an top perspective view of a back light unit according to an exemplary embodiment of the present invention;

FIG. 2 is a side sectional-tangental view of a back light unit according to an exemplary embodiment of the present invention; and

FIG. 3 is a structural diagram of a liquid crystal display according to the present invention.

### DETAILED DESCRIPTION OF EXEMPLARY EMBODIMENTS

Embodiments of the present invention will be described in detail below by referring to the accompany drawings. However, the present invention can be implemented in numerous different forms, and the present invention may not be explained to be limited hereto. Instead, these embodiments are provided for explaining the principle and actual application of the present invention, thus other skilled in the art can understand various embodiments and amendments which are suitable for specific intended applications of the present invention. In the drawings, for components being clear, thicknesses of layers and areas may be exaggerated, and the same reference signs may be used to indicate the same element in the whole description and drawings.

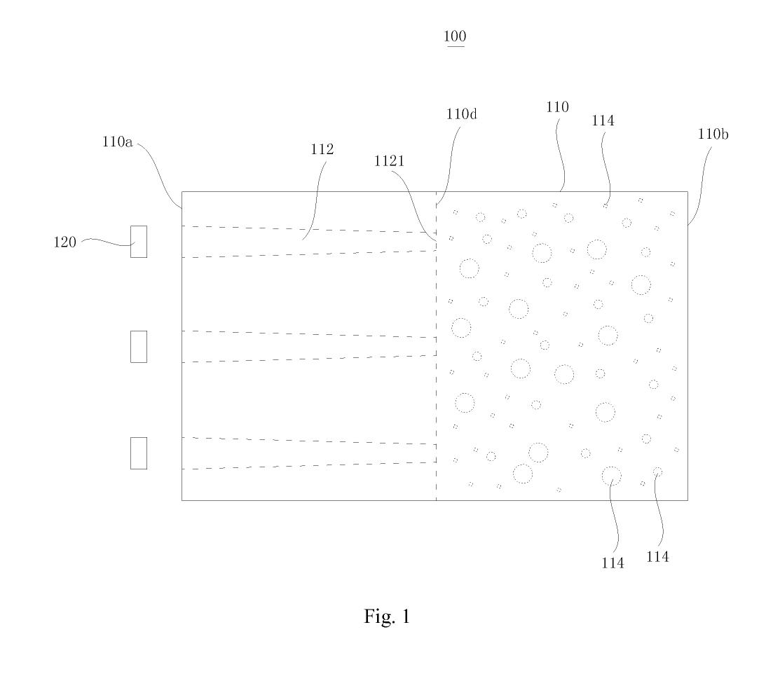

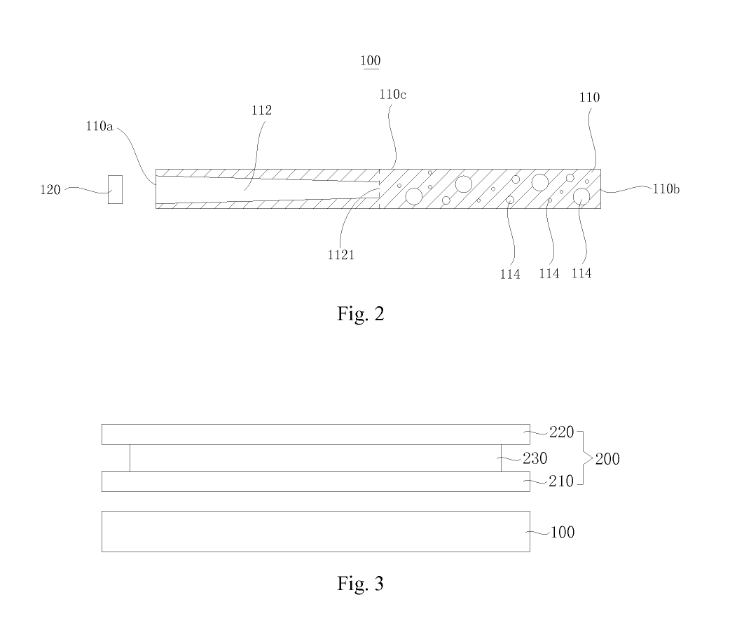

FIG. 1 is an top perspective view of a back light unit according to an exemplary embodiment of the present invention; FIG. 2 is a side sectional-tangental view of a back light unit according to an exemplary embodiment of the present invention.

Referring to FIGS. 1-2, a back light unit 100 according to the embodiment of the present invention includes a light guide plate 110 and at least one light source 120. Respective light sources 120 are disposed in a manner that the light emitting surfaces thereof face towards the light guide plate 110. It needs to be explained that the back light unit 100 according to the embodiment of the present invention further includes other necessary optical members, such as a back plate, an optical film, etc., whose details can be referred to the depiction of the prior art and are not explained here.

In the present embodiment, the light guide plate 110 may be a flat light guide plate, but the present invention is not limited thereto, the light guide plate 110 may also be a wedge light guide plate.

The light guide plate 110 includes an light incident surface 110a, a non-light-incident surface 110b opposite (preferably, directly opposite) to the light incident surface 110a, an light exit surface 110c whose sides are perpendicularly connected with the light incident surface 110a and the non-light-incident surface 110b, respectively, and a confluence surface 110d positioned between the light incident surface 110a and the non-incident surface 110b and opposite (preferably, directly opposite) to the light incident surface 110a. It needs to be explained that the confluence surface 110d is preset for easy description in the present embodiment. Preferably, the confluence surface 110d bisects the light guide plate 110 along a width direction of the light guide plate 110, that is, the distance between the light incident surface 110a and the confluence surface 110d is equal to the distance between the non-light-incident surface 110b and the confluence surface 110d.

The light incident surface 110a of the light guide plate 110 includes at least one closed groove 112 gradually reducing (tapering) from the light incident surface 110a towards the confluence surface 110d. In the present embodiment, the closed groove 112 is a cone-shaped groove, and a bottom surface thereof 1121 is a flat bottom surface, but the present invention is not limited thereto, in the other embodiments, the closed groove 112 may also be a circular cone-shaped groove.

The light source 120 faces an light incident surface 110a of the light guide plate 110 while being positioned at one side of the light guide plate 110, and the light sources 120 correspond to the closed grooves 112 on the incident surface 110a one by one. In the present embodiment, the light sources 120 are point light sources, and more particularly, are light emitting diodes (LEDs).

A refraction element 114 is disposed in the light guide plate 110 between the confluence surface 110d and the non-light-incident surface 110b. The refraction element 114 includes a plurality of refractive particles and/or a plurality of bubbles.

The light ray emitted from the light sources 120 enters inside the light guide plate 110 via the closed groove 112 on the light incident surface 110a, the light ray entering inside the light guide plate 110 is refracted again via the refraction element 114 and finally leaves the light guide plate 110 via the light exit surface 110c. During this process, the closed groove 112 allows the light conductivity to be greatly improved, the refraction element 114 increases the light refractivity so that luminance provided by the back light unit 100 to the liquid crystal display panel is more uniform.

FIG. 3 is a structural diagram of a liquid crystal display according to the present invention.

Referring to FIG. 3, the liquid crystal display according to the present application includes a liquid crystal display panel 200 and the back light unit 100, as shown in FIGS. 1 and 2, disposed opposite to the liquid crystal display panel 200, wherein the back light unit 100 provides a display light source to the liquid crystal display panel 200 so that the liquid crystal display panel 200 displays an image.

The liquid crystal display panel 200 generally comprises a Thin Film Transistor (TFT) array substrate 210, a Color Filter (CF) substrate 220 disposed opposite to the TFT array substrate, and a liquid crystal layer 230 arranged between the TFT array substrate 210 and the CF substrate 20, wherein the liquid crystal layer 230 includes a number of liquid crystal molecules. Since the specific structure of the liquid crystal display panel 200 of the present invention is the same as the structure of the liquid crystal display panel of the prior art substantially, it will not be repeated here.

To sum up, light refractivity is increased while improving light conductivity by disposing a closed groove and a refraction element in the light guide plate according to the embodiment of the present invention, thereby improving uniformity of luminance of the liquid crystal display panel.

Although the present invention is described with reference to the special exemplary embodiment, it will be understood by those skilled in the art that various changes in form and details may be made therein without departing from the spirit and scope of the invention as defined by the appended claims and its equivalents.

1. A light guide plate, comprising an light incident surface, a non-light-incident surface opposite to the light incident surface and a confluence surface positioned between the light incident surface and the non-light-incident surface and opposite to the light incident surface, wherein the light incident surface has at least one closed groove gradually reducing from the light incident surface towards the confluence surface, and a refraction element is filled between the confluence surface and the non-light-incident surface.

2. The light guide plate of claim 1, wherein the closed groove has a taper shape.

3. The light guide plate of claim 2, wherein the closed groove has a circular cone shape.

4. The light guide plate of claim 1, wherein the bottom surface of the closed groove is a flat bottom surface.

5. The light guide plate of claim 1, wherein the refraction element includes a plurality of refractive particles and/or a plurality of bubbles.

6. The light guide plate of claim 1, wherein the distance between the light incident surface and the confluence surface is equal to the distance between the non-light-incident surface and the confluence surface.

7. A back light unit, comprising:
a light guide plate comprising an light incident surface, a non-light-incident surface opposite to the light incident surface, and a confluence surface positioned between the light incident surface and the non-light-incident surface and opposite to the light incident surface, the light incident surface having at least one closed groove gradually reducing from the light incident surface towards the confluence surface, a refraction element being filled between the confluence surface and the non-light-incident surface; and
at least one light source disposed to face the light incident surface of the light guide plate and correspond to the closed grooves.

8. The back light unit of claim 7, wherein the closed groove has a taper shape.

9. The back light unit of claim 8, wherein the closed groove has a circular cone shape.

10. The back light unit of claim 7, wherein the bottom surface of the closed groove is a flat bottom surface.

11. The back light unit of claim 7, wherein the refraction element comprises a plurality of refractive particles and/or a plurality of bubbles.

12. The back light unit of claim 7, wherein the distance between the light incident surface and the confluence surface is equal to the distance between the non-light-incident surface and the confluence surface.

13. The back light unit of claim 7, wherein the light source is a point light source.

14. The back light unit of claim 13, wherein the light source is a light emitting diode.

15. A liquid crystal display, comprising a back light unit and a liquid crystal display panel disposed opposite to the back light unit, the back light unit provides a display light source for the liquid crystal display panel so that the liquid crystal display panel displays an image, wherein the back light unit comprises:
a light guide plate comprising an light incident surface, a non-light-incident surface opposite to the light incident surface, and an confluence surface positioned between the light incident surface and the non-light-incident surface and opposite to the light incident surface, the light incident surface having at least one closed groove gradually reducing from the light incident surface towards the confluence surface, a refraction element being filled between the confluence surface and the non-light-incident surface; and
at least one light source disposed to face the light incident surface of the light guide plate and correspond to the closed grooves.

16. The liquid crystal display of claim 15, wherein the closed groove has a taper shape.

17. The liquid crystal display of claim 16, wherein the closed groove has a circular cone shape.

18. The liquid crystal display of claim 15, wherein the bottom surface of the closed groove is a flat bottom surface.

19. The liquid crystal display of claim 15, wherein the refraction element comprises a plurality of refractive particles and/or a plurality of bubbles.

20. The liquid crystal display of claim 15, wherein the distance between the light incident surface and the confluence surface is equal to the distance between the non-light-incident surface and the confluence surface.
